(19) United States
(12) Patent Application Publication
(10) Pub. No.: US 2004/0058765 A1
(43) Pub. Date: Mar. 25, 2004

(54) Static link chain

(75) Inventors: Dietmar Kubein-Meesenburg, Goettingen (DE); Hans Naegerl, Gleichen (DE); Dankmar Ihlow, Sierksdorf (DE)

Correspondence Address: CROWELL & MORING LLP, INTELLECTUAL PROPERTY GROUP, P.O. BOX 14300, WASHINGTON, DC, 20044-4300, US

(73) Assignee: HJS Gelenksystem GmbH, Muenchen (DE)

(21) Appl. No.: 10/463,858

(22) Filed: Jun. 18, 2003

Related U.S. Application Data
(63) Continuation of application No. PCT/DE01/04577, filed on Dec. 7, 2001.

(30) Foreign Application Priority Data
Dec. 18, 2000 (DE) 100 63 149.5

(51) Int. Cl. F16G 13/02

(52) U.S. Cl. 474/206

(57) ABSTRACT

A static link chain (4) composed of a number of chain links (1,2) each made up of a short tensioned chain link part (2) and a long compression-loaded chain link part (1), both of which overlap and are joined to each other by bushing joints (3). A clamping device (7,8), which is subjected to tensile force and which stabilizes the link chain (4) under load, is affixed to the long chain link parts (1) at a distance A parallel to the bushing joints (3).

### CROSS REFERENCE TO RELATED APPLICATIONS

This application is a continuation of international patent application no. PCT/DE01/04577, filed Dec. 7, 2001, designating the United States of America, and published in German as WO 02/50451, the entire disclosure of which is incorporated herein by reference. Priority is claimed based on Federal Republic of Germany patent application no. DE 100 63 149.5, filed Dec. 18, 2000.

### BACKGROUND OF THE INVENTION

The invention relates to a static link chain composed of a plurality of chain links. The link chains known in the prior art are only stable in the pull direction, so that their range of potential uses is limited.

French patent application no. FR 2,614,380 A1 discloses a link chain composed of short and long chain link parts, which is used as a circulating conveyor belt. Here, the link chain rests on supporting slide rails 24 and thus is stabilized in load direction.

### SUMMARY OF THE INVENTION

It is an object of the invention to provide an improved static link chain.

Another object of the invention is to provide a static link chain which is stable in the load plane without requiring any supports.

These and other objects are achieved in accordance with the present invention by providing a static link chain made of a plurality of chain links, each link being comprised of a short, tensile-loaded chain link part and a long, compression-loaded chain link part, with the short and long parts overlapping each other and being interconnected by bushing joints, wherein each link further comprises a tensile-loaded tensile device affixed to the long chain link parts at a distance A parallel to the bushing joints, and wherein said tensile device stabilizes the link chain under load.

Further advantageous aspects and embodiments of the invention are described in additional detail hereinafter.

In accordance with the invention, the chain links are each composed of a short tensile-loaded chain link part and a long compression-loaded chain link part, which overlap one another and are interconnected by bushing joints. At a distance A, parallel to the bushing joints, a tensile-loaded tension device is fixed to the long chain link parts and stabilizes the link chain under load. The tension device prevents the link chain from buckling under load. The link chain instead becomes more stable and rigid as the load increases because of the existing physically stable state.

The range of potential applications for the invention can advantageously be expanded if two tension devices are provided, one on each side, which are alternately loaded as needed. In this case, the link chain is stable in two load directions.

In a further embodiment, it may be advantageous if the distance (A) between the bushing joints and the tension device is variable. In this case, the arrangement of the chain links is adjustable in an arc. This effect is also achieved if the length of the tension device is variable, e.g., by means of a control unit.

Within the scope of the invention, it may further be provided that the tension device is formed by bar-shaped tension members that are coupled to the long chain link parts. Preferably, the bar-shaped tension members are provided in the area of their bushing joints with oblong holes extending in longitudinal direction. In particular, these oblong holes also ensure alternating loadability when two tension devices are provided.

If the length of the bar-shaped tension members is adjustable, the chain links of the link chain can be pivoted in a precisely defined manner.

As an alternative, the bar-shaped tension members can also be displaceable in the area of the oblong holes for length adjustment.

In accordance with a further embodiment of the invention, the tension device is formed as a continuous ribbon-like tension element. This embodiment, too, makes it possible to pivot the chain links of the link chain by means of a control unit. The tension device can furthermore be arranged in such a way that an arcuate arrangement of the chain links results. This is advantageous if the link chain is used, for example, as a bridge or a vault.

According to another preferred embodiment, the long chain link parts have angled sections at their ends in which the bushing joints for the short chain link parts are disposed. This makes it possible to arrange the short chain link parts in the center within the long chain link parts to avoid a disadvantageous one-sided bearing arrangement of the bushing joints.

In accordance with another preferred embodiment, the link chain is used as a bridge. In such a case, the tension device is preferably mounted on the inner circumference of the bridge if it curves upwardly and on the outer circumference if it curves downwardly. This arrangement of the tension device prevents the bridge from buckling under load when the bridge is compressed. Instead it becomes more stable and rigid as the load increases. When a load is applied, a movement occurs in the direction of the extended position and, as a result, the bridge becomes stiffer.

Arranging prefabricated modules in a row permits a flexible construction or preassembly of the bridge. The length and curvature of the bridge can be easily varied. Preassembled segments can be folded for transport if necessary. Basically, pylons and piers are not required.

### BRIEF DESCRIPTION OF THE DRAWINGS

The invention will be described in further detail hereinafter with reference to illustrative preferred embodiments shown in the accompanying drawing figures, in which:

FIG. 1 is a partial perspective view of a link chain with two tension devices, one on each side;

FIG. 2 is an enlarged partial side view of a link chain with two tension devices, one on each side, in which the long chain link parts are U-shaped;

FIG. 3 is a partial view of a link chain, whose tension device is formed by bar-shaped tension members; and

FIG. 4 is a partial view of a link chain whose bilateral tension device is formed by bar-shaped tension members.

### DETAILED DESCRIPTION OF PREFERRED EMBODIMENTS

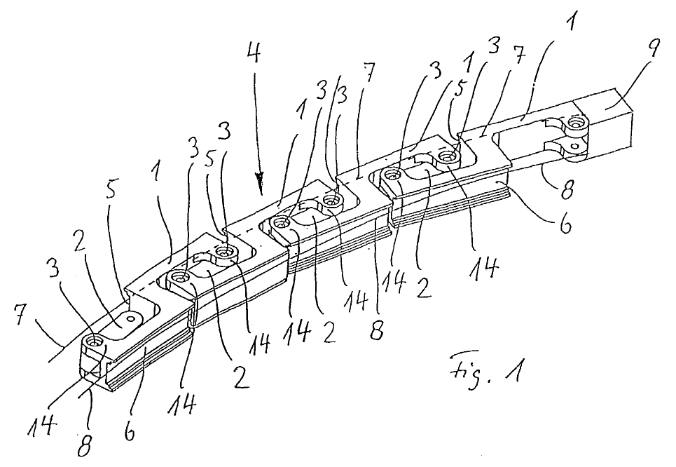

FIG. 1 shows a static link chain 4 formed by chain links, each of which is composed of a long compression-loaded chain link part 1 and a short tensile-loaded chain link part 2, which overlap one another and are interconnected by bushing joints 3. The long chain link parts 1 have angled sections 14 at their ends, in which the bushing joints 3 are disposed. On the topside and the bottom side of the long chain link parts 1, each long chain link part 1 has a groove 5 or 6 to guide cables 7 and 8, which form two tension devices 7, 8, one on each side.

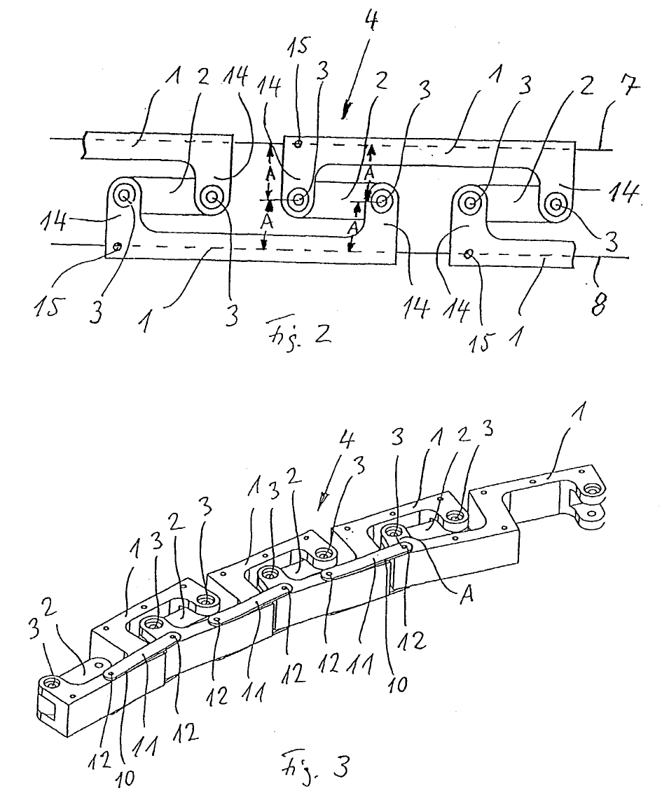

As shown in FIG. 2, the cables 7 and 8 of the tension devices are disposed at a distance A from the bushing joints 3 and are held in mounts or fasteners 15. The bilaterally effective tension devices 7 and 8 stabilize the chain links 1, 2 of the link chain 4 under load. If the cables 7 and 8 of the tension devices are adjustable in length, a precisely defined pivotability of the chain links 1, 2 of the link chain 4 can be achieved. A control device 9 is provided for this purpose. The fasteners 15 of the tension devices 7 and 8 are made detachable so that the chain links 1, 2 of the link chain 4 can be adjusted. Electric or hydraulic actuators or locks may be provided for this purpose.

According to the embodiment shown in FIG. 2, the long chain link parts 1 of the link chain 4 can also have a mutually overlapping U-shaped configuration.

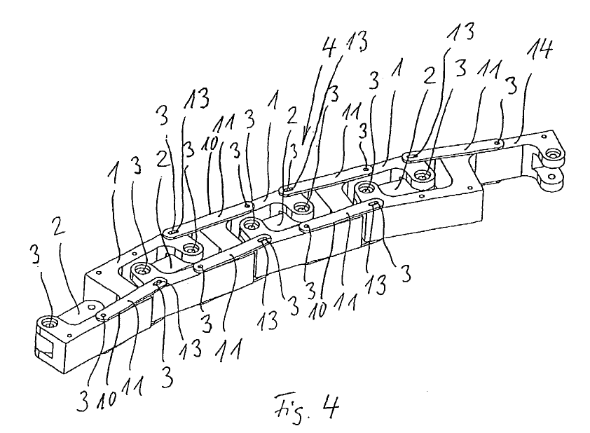

FIG. 3 shows a link chain 4 having a tension device 11 formed by bar-shaped tension members 10 arranged on one side. The tension members 10 are fastened to the chain links 1 and 2 by joints 12 at a distance A from the bushing joints 3 to form a four-bar mechanism. The bottom tension device 11 stabilizes the chain links 1, 2 of the link chain 4. An arc, e.g., a bridge with a curvature defined by the tension device 11 is formed. The bar-shaped tension members 10 are tensile-loaded (i.e., under tension).

FIG. 4 shows a link chain 4 with chain links 1 and 2 on which bar-shaped tension members 10 are mounted on both sides of the chain links 1 and 2 by joints 12 spaced a distance A from the bushing joints 3, forming two tension devices 11. In this case, the tension members 10, in the area of their joints 12, are provided with oblong holes 13 extending in a longitudinal direction. The resulting play in the tension devices 11 produces load stability of the link chain 4 in both loading directions even if the loading directions alternate. As a function of the loading direction, one of the two tension devices 11 is alternately subjected to a tensile load thereby stabilizing the link chain 4, while the other tension device 11 is unloaded.

In the illustrative embodiment shown in FIG. 4, the bar-shaped tension members 10 or the short tensile-loaded chain link parts 2 can be provided with oblong holes in the area of their bushing joints 3. This has the advantage that the link chain 4 is pivotable. It is also possible to vary the arcuate shape of the chain links 1, 2 by a controlled adjustment of the length of the bar-shaped tension members 10 or the short chain link parts 2, which can be configured e.g., in the manner of a telescope and which can be hydraulically actuated. It is also possible to make the effective length of the tension members 10 or the short chain link parts 2 adjustable in the area of their oblong holes, e.g., by means of a pinion gear arranged there. The distances A between the bushing joints 3 of the short chain link parts 2 and the tension device 7, 8, 11 can also be made adjustable in this or a similar maner.

In practice, the link chain 4 according to the invention has many advantageous applications, e.g., as a bridge. Since the curvature of the bridge can be varied, the bridge can be adapted to different loads. Because no pylons and piers are required, no anchoring of support cables is necessary, and the supported load consists only of the bridge itself. The bridge is constructed by horizontally joining the individual chain links, which are then set upright. Stabilization is achieved by applying a load, primarily through the weight of the bridge itself. A continuous travel path can be supported along the outer circumference of the bridge if the bridge is curved upwardly or along the inner circumference if it is curved downwardly. Furthermore an additional tension device can be arranged in the horizontal plane at a right angle to the outer or inner tension device to curve the bridge in its longitudinal extension.

The bridge according to the invention is resistant against storms, vibrations and earthquakes, especially if the bridge is not fixed at its ends or is only fixed at one end. Preferably, two or more link chains are arranged parallel to each other to obtain the width required, for example, for a travel path.

The bridge according to the invention also is easy to repair. For example, to replace one of the chain links, the preceding and the subsequent chain links can be interlocked to make it possible to remove the chain link that is to be replaced. Furthermore, the tension device is variable and can be replaced without complex auxiliary structures.

The link chain according to the invention can furthermore be used as a vault or arch. Such an arch has the same advantages as the bridge construction. In particular, the arch, too, can be flexibly constructed and preassembled by arranging prefabricated modules in a row. The length of the arch is variable. By selecting an appropriate size of the curvature, the arch can be designed for different load bearing capacities. Pillars are not required. An arch according to the invention is also resistant against storms, vibrations and earthquakes. Moreover, it is easy to repair.

The link chain can also be used as gripping fingers e.g., of robots. This requires, however, that a tension device be arranged on each side of the chain links. This tension device determines the curvature of the gripping finger. A control device can be used to adjust the length of the tension devices or to adjust the distance A of the link chains to impart a defined curve to the gripping finger. A load can be applied in the bending direction or in the stretching direction. In such a case, the tension devices are designed such that they are tensile-loaded.

The link chain can also be used as a coupling member in a pushing unit between one ship pushing another. Such a coupling member makes it possible to adapt coupled ships as a unit to the bends of a river. The pushing ship and the pushed ship are joined using a link chain according to the invention. A tension device is mounted on each side of the chain links. The tension devices control the curvature of the link chain, i.e., the relative angle between the pushing ship and the pushed ship. A control device is provided for this purpose.

It may furthermore be advantageous to use the link chain as a component in oscillating systems for transmitting oscillations to system components, e.g., to vibrators, test stands, mixers or similar units.

Due to their high inherent stability, it may also be advantageous to use link chains as damping elements in structures. Here, a link chain 4 according to the invention can be used, for example, as a supporting column or a supporting beam.

The link chain 4 can also be used in medical technology as a control system for endoscopic instruments, e.g., for proctoscopy. It can also be used as a control system in pipe inspection equipment.

Furthermore, wind turbines, preferably Flettner rotors, can be installed on the chain links 1, 2 of a bridge. In addition to generating power, this also makes it possible to optimize the wind conditions on the travel way and to control vibration damping. The segments can be encapsulated to protect them against atmospheric exposure.

It is also feasible to use the link chain in a bearing construction for pillars, e.g., of a maglev train, which not only absorbs the load but also allows a readjustment of the line itself.

The foregoing description and examples have been set forth merely to illustrate the invention and are not intended to be limiting. Since modifications of the described embodiments incorporating the spirit and substance of the invention may occur to persons skilled in the are, the invention should be construed broadly to include all variations within the scope of the appended claims and equivalents thereof.

What is claimed is:

1. A static link chain made of a plurality of chain links, each said link being comprised of a short, tensile-loaded chain link part and a long, compression-loaded chain link part, said short and long parts overlapping each other and being interconnected by bushing joints, wherein each link further comprises a tensile-loaded tensile device affixed to the long chain link parts at a distance A parallel to the bushing joints, and wherein said tensile device stabilizes the link chain under load.

2. A link chain according to claim 1, wherein each link comprises a total of two tension devices, one on each side, which are alternately loaded as needed.

3. A link chain according to claim 1, wherein the distance A between the bushing joints and the tension device is variable such that the arrangement of the chain links can be adjusted in an arc.

4. A link chain according to claim 1, wherein the tension device is formed by bar-shaped tension members coupled to the long chain link parts.

5. A link chain according to claim 4, wherein the bar-shaped tension members are provided in the area of their bushing joints with oblong holes extending in a longitudinal direction.

6. A link chain according to claim 5, wherein the bar-shaped tension members are adjustable in length.

7. A link chain according to claim 1, wherein the tension device is formed by a continuous, ribbon-like tension element.

8. A link chain according to claim 1, wherein the long chain link parts have angled sections at their ends in which the bushing joints for the short chain link parts are disposed.
